(19) United States
(12) Patent Application Publication
(10) Pub. No.: US 2008/0174283 A1
(43) Pub. Date: Jul. 24, 2008

(54) Robust Ground Start Detection

(76) Inventors: Michel Ivgi, Yehud (IL); Offir Assayag, Ramat Gan (IL); Gordon E. Gustafson, Tinton Falls, NJ (US); Jeffrey Robert Clobes, Howell, NJ (US); Yuval Cohen, Rishon-Lezion (IL)

Correspondence Address: RYAN, MASON & LEWIS, LLP, 90 FOREST AVENUE, LOCUST VALLEY, NY, 11560, US

(21) Appl. No.: 11/625,942

(22) Filed: Jan. 23, 2007

(51) Int. Cl. G05F 1/00

(52) U.S. Cl. 323/265

(57) ABSTRACT

A communication card including a card substrate, a power interface adapted to receive power from a power source and distribute it to elements mounted on the card substrate and a ground start detection circuit on the card substrate. The card additionally includes an active current regulating circuit adapted to receive electrical power through the power interface, regulate a provided current responsive to the received electrical power and provide the regulated current to the ground start detection circuit.

### FIELD OF THE INVENTION

The present invention relates to communication apparatus and particularly to ground start detection circuits.

### BACKGROUND OF THE INVENTION

Communication tasks generally require large processing resources in order to perform tasks such as encoding/decoding, encryption/decryption and protocol conversions. While general purpose computers could be used to perform these tasks, in most cases dedicated cards are used. The cards are designed in predetermined sizes, and compatible racks are designed to operatively receive the cards, allowing service providers to add cards as needed.

It is desired to fit as many as possible processing units on each card, thus maximizing the number of communication connections each card can handle, and hence the number of connections each rack can handle.

Communication ports utilize a significant amount of the area of the card. In an exemplary card, 60-70% of the area of the card is occupied by digital circuits and the remaining area of the card is allocated to an analog portion including the ports. If each port requires about 8% of the area of the card, limiting the digital portion and other elements of the analog portion to up to 68% of the area of the card leaves sufficient room for four ports, allowing two line ports and two trunk ports. If the digital portion and other analog elements require 70% of the area of the card or more, the card may be limited to having only a single line port and a single trunk port.

One of the circuits included in the digital portion is a ground start detection circuit, which is used to identify when a remote end communication unit approves a connection. The ground start detection circuit includes an opto-coupler detector and a MOSFET connected to a switch on the side of the central office (CO) communication unit. When the switch is closed by the CO, current flows from the switch through the opto-coupler detector and MOSFET, into the voltage source. The opto-coupler detector detects the current flow as initiation of a communication call. The opto-coupler is allowed to receive currents only within its operation limits, as currents outside the limits may burn out the opto-coupler. A resistor, which is generally of negligible area, is placed between the voltage source and the switch, which provides a ground voltage, in order to set the current to a desired level. The ground voltage provided from the switch of the CO may be inaccurate, causing the current passing through the opto-coupler to differ from the intended ground value. Such inaccuracies are generally within the operable limits of the ground start circuit.

### SUMMARY OF THE INVENTION

An aspect of some embodiments of the present invention relates to a communication card including a ground start detection unit, which additionally includes an active current regulating circuit. Possibly, the current regulating circuit increases the area of the card occupied by the ground start detection unit by at least 5%, 10% or even at least 20%, according to the card's size and the required port count. While the use of a current regulating unit increases the area of the card occupied by the ground start detection unit, it substantially eliminates the possibility of a power surge, occurring exactly during a ground start signaling event, burning out the opto-coupler. It is one aspect of some embodiments of the invention that the advantages of avoiding the rare risk of such a burn-out of the opto-coupler, outweigh the disadvantage of utilizing additional card area.

In some embodiments of the invention, the current regulating circuit comprises a current source having a constant current with an error level of less than 20%, 10% or even less than 5%. Alternatively, the current regulating circuit comprises a DC-DC converter which increases the voltage provided to the opto-coupler and thus reduces the sensitivity of the current to spikes in the voltage.

There is therefore provided in accordance with an exemplary embodiment of the invention, a communication card, comprising a card substrate, a power interface adapted to receive power from a power source and distribute it to elements mounted on the card substrate, a ground start detection circuit on the card substrate and an active current regulating circuit adapted to receive electrical power through the power interface, regulate a provided current responsive to the received electrical power and provide the regulated current to the ground start detection circuit.

Optionally, the active current regulating circuit requires at least 10% or even at least 20% of the size of the area of the substrate required by the ground start detection circuit. Optionally, the active current regulating circuit requires at least 1% of the area of the substrate utilized for electronic elements. Optionally, the active current regulating circuit comprises at least two transistors. Optionally, the active current regulating circuit provides a fixed current level with a variation error of less than 20% or even less than 10%. In some embodiments of the invention, the elements of the card are adapted to operate with a voltage level of less than 25 volts. Optionally, the active current regulating circuit is adapted to receive electrical power with a voltage level of less than 20 volts.

### BRIEF DESCRIPTION OF THE DRAWINGS

The present invention will now be described in the following detailed description of exemplary embodiments thereof and with reference to the attached drawings, in which same or similar number designations are maintained throughout the figures for each element and in which dimensions of components and features shown in the figures are chosen for convenience and clarity of presentation and are not necessarily shown to scale. Generally, only structures, elements or parts that are germane to the discussion are shown in the figures. The figures are to listed below.

FIG. 1 is a schematic illustration of a communication card, in accordance with an exemplary embodiment of the invention;

FIG. 2 is a schematic circuit layout of a ground start detection circuit, in accordance with an exemplary embodiment of the invention;

FIG. 3 is a schematic circuit layout of a ground start detection circuit illustrating the internal structure of a current source of the circuit, in accordance with an exemplary embodiment of the invention; and

FIG. 4 is a schematic circuit layout of a ground start detection circuit, in accordance with another exemplary embodiment of the invention.

### DETAILED DESCRIPTION OF SOME EMBODIMENTS

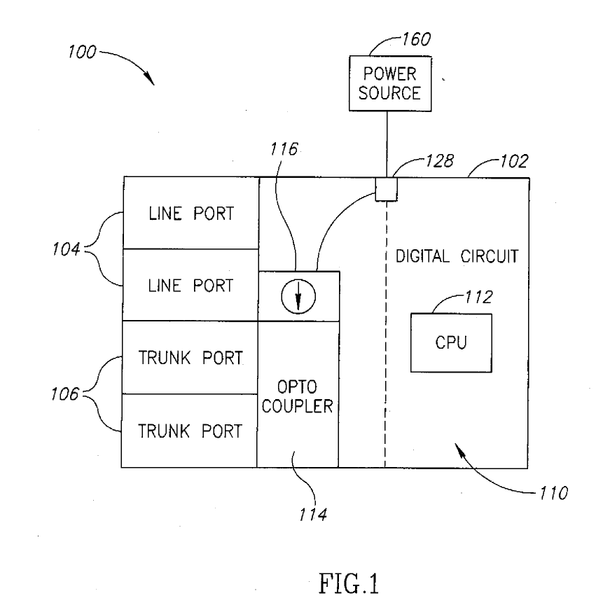

FIG. 1 is a schematic illustration of a communication card 100, in accordance with an exemplary embodiment of the invention. Communication card 100 optionally comprises a substrate 102 of a predetermined size adapted to be inserted in a compatible rack (not shown).

Substrate 102 carries a plurality of electronic elements which implement the various tasks of communication card 100. In an exemplary embodiment of the invention, card 100 includes two line ports 104, which connect to subscribers, and two trunk ports 106, which connect to a trunk line. Alternatively, card 100 may include other types of ports and/or other numbers of ports, from only one or two ports to dozens or more ports, depending on the application and the specific card. Card 100 further typically includes a digital circuit portion 110, which comprises various units such as processor 112 (e.g., a DSP), which process the signals transmitted on the communication lines handled by the card. Card 100 also includes a ground start detection circuit including an opto-coupler 114 and a current source 116, which provides a relatively accurate current signal to opto-coupler 114. Opto-coupler 114 may be implemented using any structure known in the art, for example that described in U.S. Pat. No. 4,563,547, which issued on Jan. 7, 1986 to Booth, the disclosure of which is incorporated herein by reference.

A power interface 128 optionally connects to a power source 160, for example a power source of the rack, and distributes the power throughout card 100, including to current source 116. Power interface 128 optionally receives a nominal voltage of a fixed value, for example, +/−48 volts, +/−24 volts or +/−12 volts.

Electronic elements may be located on a single face of substrate 102 or on both faces of the substrate. In addition, card 100 may include additional areas for placing electronic ports, such as flaps, add-ons or any other implementations that provide additional area to the card.

Card substrate 102 optionally has an area of between 100 to 1000 square centimeters, although larger or smaller cards may be used. In an exemplary embodiment of the invention, card substrate 102 has an area of 20 cm×20 cm. Another exemplary card in accordance with embodiments of the invention, has an area of 15×7 centimeters.

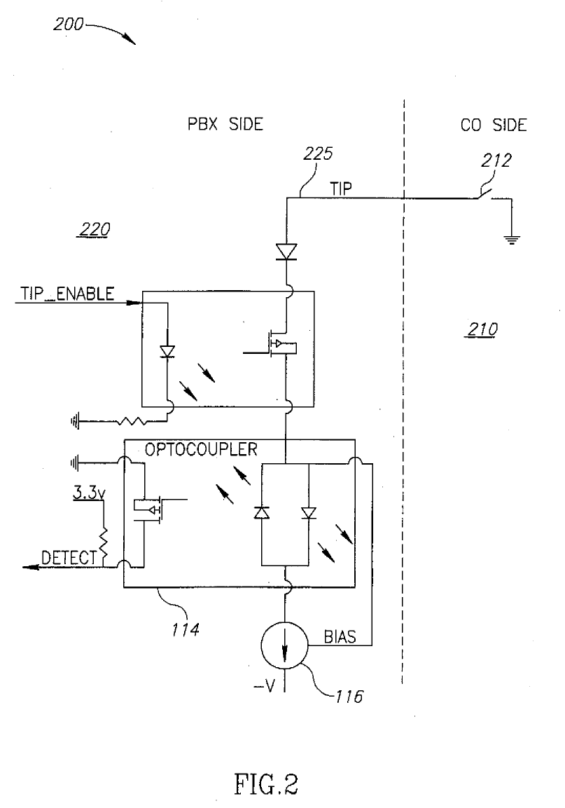

FIG. 2 is a schematic electric diagram of a ground start signaling circuit 200, in accordance with an exemplary embodiment of the invention. On a central office (CO) end 210, a switch 212 is used to signal an incoming connection on a TIP line 225. On a public switch (PBX) end 220, located for example on communication card 100, current source 1 16 provides a predetermined current level, when switch 212 is closed. The current passes through opto-coupler 1114, which identifies the signal on PBX end 220.

When switch 212 is closed, TIP line 225 carries a nominal ground voltage. It is noted, however, that the TIP voltage may not be accurate and may have errors of more than 20%, 40% or even more than 60% of the nominal voltage value of power source 160. The errors may be due, for example, to potential differences between the ground on the CO end and the ground on the PBX end. In addition, the TIP voltage may suffer from short polarity reversals and spikes.

Current source 116 optionally provides a current level required by opto-coupler 114, for example about 3 milliamps. The current provided by current source 116 optionally has an error level which allows it to be considered by engineers substantially constant, for example less than 15%, less than 10% or even less than 5% or 3% of the current provided by current source 106. In an exemplary embodiment of the invention, current source 116 has an error of less than 0.3 or even less than 0.1 milliamps. In some embodiments of the invention, current source 116 is implemented by an active circuit, possibly including at least one or even at least two transistors.

Current source 116 is optionally relatively complex, adding at least 10% or even at least 20% to the card area required for implementing the ground start detection circuit. Possibly, the current source requires more than 1% of the area of card 100. While current source 116 is area consuming, it provides various advantages which the inventors of the present application consider to outweigh the disadvantage of wasted area. Use of current source 116 substantially eliminates the possibility that a voltage surge on TIP line 225, for example due to lightning, occurring exactly at the time of a ground start signaling, will cause opto-coupler 114 to burn out. That is, use of current source 1 16 reduces the accuracy required from the power source of the rack, such that the TIP line is allowed to have substantial power surges and to provide voltage levels of more than 10%, 20% or even more than 50% of the voltage provided to power interface 128. This alleviation of the accuracy of the requirements from TIP line 225 and the power source allows using a low voltage power source, for example of 24 volts or lower, 12 volts or lower and even as low as 9 volts or lower.

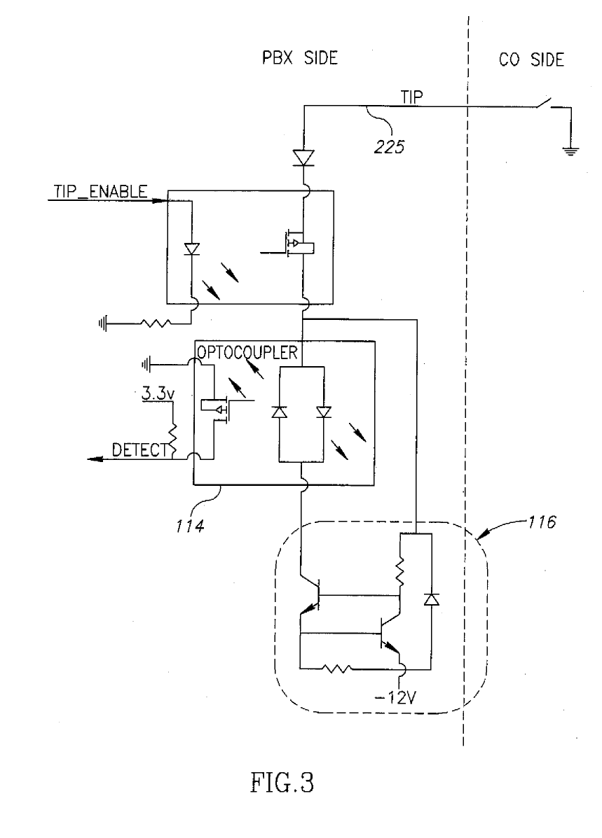

FIG. 3 is a schematic of ground start signaling circuit 200, showing an implementation of current source 116, in accordance with an exemplary embodiment of the invention. It is noted that this implementation is shown only as an example and many other current source implementations may be used.

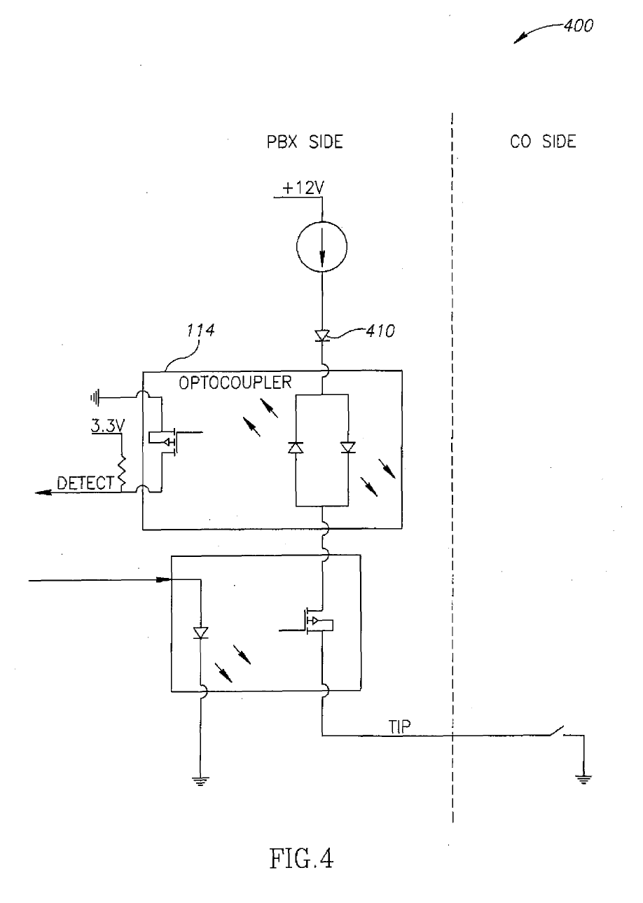

FIG. 4 is a schematic electric diagram of a ground start signaling circuit 400, in accordance with another exemplary embodiment of the invention. In the embodiment of FIG. 4, the current source is connected to a positive voltage level, instead of a negative voltage. This embodiment also illustrates the use of a diode 410, which prevents reverse currents from aversely affecting opto-coupler 1 14.

In some embodiments of the invention, current source 116 is replaced by a DC-DC converter which raises the voltage supplied to opto-coupler 114 to a sufficiently high level, such that inaccuracies in the provided voltage have small effect on the current passing through opto-coupler 114. It is noted, however, that a DC-DC converter generally requires at least twice or even at least four times the area required by a current source.

It will be appreciated that the above described apparatus may be varied in many ways, including, changing the layouts, materials, elements and structures used. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments describe the best mode 5 contemplated by the inventors and therefore include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A communication card, comprising:
a card substrate;
a power interface adapted to receive power from a power source and distribute it to elements mounted on the card substrate;
a ground start detection circuit on the card substrate; and
an active current regulating circuit adapted to receive electrical power through the power interface, regulate a provided current responsive to the received electrical power and provide the regulated current to the ground start detection circuit.

2. A communication card according to claim 1, wherein the active current regulating circuit requires at least 10% of the size of the area of the substrate required by the ground start detection circuit.

3. A communication card according to claim 2, wherein the active current regulating circuit requires at least 20% of the size of the area of the substrate required by the ground start detection circuit.

4. A communication card according to claim 1, wherein the active current regulating circuit requires at least 1% of the area of the substrate utilized for electronic elements.

5. A communication card according to claim 1, wherein the active current regulating circuit comprises at least two transistors.

6. A communication card according to claim 1, wherein the active current regulating circuit provides a fixed current level with a variation error of less than 20%.

7. A communication card according to claim 1, wherein the active current regulating circuit provides a fixed current level with a variation error of less than 10%.

8. A communication card according to claim 1, wherein the elements of the card are adapted to operate with a voltage level of less than 25 volts.

9. A communication card according to claim 1, wherein the active current regulating circuit is adapted to receive electrical power with a voltage level of less than 20 volts.
